(19) United States
(12) Patent Application Publication
(10) Pub. No.: US 2017/0294097 A1
(43) Pub. Date: Oct. 12, 2017

(54) AUTOMATED NAP MODE

(71) Applicant: Vivint, Inc., Provo, UT (US)

(72) Inventor: Adam K. Webb, Provo, UT (US)

(21) Appl. No.: 15/094,067

(22) Filed: Apr. 8, 2016

(51) Int. Cl. G08B 21/06; G08B 5/38; H04L 12/28; G08B 3/10

(52) U.S. Cl. CPC G08B 21/06; G08B 3/10; G08B 5/38; H04L 12/2838; H04L 2012/2841

(57) ABSTRACT

A method for a nap mode in a security/automation system is described. In one embodiment, the method may include detecting a trigger for a nap mode of a home automation system and upon detecting the nap mode trigger, activating the nap mode of the home automation system.

### BACKGROUND

The present disclosure, for example, relates to security and/or automation systems, and more particularly to automated nap mode.

Security and automation systems are widely deployed to provide various types of communication and functional features such as monitoring, communication, notification, and/or others. These systems may be capable of supporting communication with a user through a communication connection or a system management action.

When an occupant of a premises lies down for a nap and/or puts another down for nap time, the nap may be interrupted by various noises, unexpected disturbances, etc. A system to minimize such disturbances would help to avoid waking a napping occupant.

### SUMMARY

The present systems and methods may improve operations of a security/automation system in relation to an occupant of a premises taking a nap. A method for a nap mode in a security/automation system is described.

In one embodiment, the method may include detecting a trigger for a nap mode of a home automation system and upon detecting the nap mode trigger, activating the nap mode of the home automation system. In some cases activating the nap mode may include modifying an audio setting of a dedicated chime connected to a doorbell at a premises associated with the home automation system. Additionally, or alternatively, modifying the audio setting of the dedicated chime includes at least one of muting the dedicated chime, bypassing the dedicated chime, decreasing a volume of the dedicated chime, and playing a chime sound over a first speaker of the home automation system while bypassing playing the chime sound over a second speaker.

In some embodiments, the method may include detecting the doorbell at the premises being rung and routing a doorbell notification to an alternative destination. In some cases, the doorbell notification includes at least one of a sound played on a mobile device, a message displayed on the mobile device, a message displayed on a television screen, a message displayed on a control panel of the home automation system, flashing a light of a sensor of the home automation system, and flashing a security or strobe light of the home automation system.

In some embodiments, the method may include identifying a room where an occupant is napping and muting a speaker in the room where the occupant is napping while the home automation system is in nap mode. In some cases, detecting the trigger for the nap mode includes at least one of identifying a scheduled nap mode set for a predetermined period of time, identifying a voice command to initiate the nap mode, detecting an occupant in a bedroom lying down and remaining still for a predetermined amount of time, detecting a sound machine being activated, and monitoring a vital sign of the occupant that includes at least one of pulse, heart rate, breathing, breathing rate and determining the monitored vital sign indicates the occupant is napping.

Upon detecting the trigger for the nap mode, the method may include activating a motion sensor in the room where an occupant is napping and determining whether detected motion indicates the occupant is awake. In some embodiments, upon detecting the trigger for the nap mode, the method may include activating a decibel meter in the room where an occupant is napping and determining whether a detected sound indicates the occupant is awake.

In some embodiments, upon detecting the trigger for the nap mode, the method may include playing a sound in the room where an occupant is napping, the sound including at least one of white noise and one or more sounds of nature comprising ocean sounds, river sounds, rain sounds, wind sounds.

In some embodiments, the method may include measuring an ambient noise level relative to the room where the occupant is napping and upon detecting a noise that exceeds a predetermined threshold, adjusting an aspect of the sound being played in the room to mask the detected noise. In some embodiments, upon determining the occupant is awake after a nap, the method may include generating a notification indicating the occupant is awake, deactivating nap mode, and restoring the audio setting of the chime to a default mode.

An apparatus for client side queue sharding is also described. In one embodiment, the apparatus may include a processor, memory in electronic communication with the processor, and instructions stored in the memory, the instructions being executable by the processor to perform the steps of detecting a trigger for a nap mode of a home automation system and upon detecting the nap mode trigger, activating the nap mode of the home automation system. In some cases activating the nap mode may include modifying an audio setting of a dedicated chime connected to a doorbell at a premises associated with the home automation system. Additionally, or alternatively, modifying the audio setting of the dedicated chime includes at least one of muting the dedicated chime, bypassing the dedicated chime, decreasing a volume of the dedicated chime, and playing a chime sound over a first speaker of the home automation system while bypassing playing the chime sound over a second speaker.

A non-transitory computer-readable medium is also described. The non-transitory computer readable medium may store computer-executable code, the code being executable by a processor to perform the steps of detecting a trigger for a nap mode of a home automation system and upon detecting the nap mode trigger, activating the nap mode of the home automation system. In some cases activating the nap mode may include modifying an audio setting of a dedicated chime connected to a doorbell at a premises associated with the home automation system. Additionally, or alternatively, modifying the audio setting of the dedicated chime includes at least one of muting the dedicated chime, bypassing the dedicated chime, decreasing a volume of the dedicated chime, and playing a chime sound over a first speaker of the home automation system while bypassing playing the chime sound over a second speaker.

The foregoing has outlined rather broadly the features and technical advantages of examples according to this disclosure so that the following detailed description may be better understood. Additional features and advantages will be described below. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein—including their organization and method of operation—together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following a first reference label with a dash and a second label that may distinguish among the similar components. However, features discussed for various components—including those having a dash and a second reference label—apply to other similar components. If only the first reference label is used in the specification, the description is applicable to any one of the similar components having the same first reference label irrespective of the second reference label.

FIG. 1 is a block diagram of an example of a security and/or automation system in accordance with various embodiments;

FIG. 2 shows a block diagram of a device relating to a security and/or an automation system, in accordance with various aspects of this disclosure;

FIG. 3 shows a block diagram of a device relating to a security and/or an automation system, in accordance with various aspects of this disclosure;

FIG. 4 shows a block diagram relating to a security and/or an automation system, in accordance with various aspects of this disclosure;

FIG. 5 shows a block diagram of a flow of operations relating to a security and/or an automation system, in accordance with various aspects of this disclosure

FIG. 6 is a flow chart illustrating an example of a method relating to a security and/or an automation system, in accordance with various aspects of this disclosure; and

FIG. 7 is a flow chart illustrating an example of a method relating to a security and/or an automation system, in accordance with various aspects of this disclosure.

### DETAILED DESCRIPTION

Parents of toddlers and newborns are often frustrated when a noise happens just after lying down their child for a nap. One common occurrence is a doorbell being rung just after the child goes down for a nap. Also, after lying the child down for a nap, the parent may be out of earshot when the child wakes up. Accordingly, benefits may be achieved from systems and methods to enable a nap mode on a home automation system to minimize potential disturbances and provide notifications to a parent of a napping child.

In one embodiment, a home automation system may detect a trigger for a nap mode. For example, in conjunction with one or more sensors, the home automation system may detect an occupant (e.g., baby, child, parent,) lying down in a room of a home and then lying still. Based on these detected events, the system may put itself into a nap mode. In some cases, the system may detect a sleep sound machine being turned on and played (e.g., soothing sounds such as a running river, ocean waves, rain, etc.). Upon detecting the sleep sound machine being played, the system may put itself into nap mode. In some embodiments, the system may monitor a vital sign of an occupant (e.g., breathing, breathing rate, pulse, heart rate, etc.). Based on the monitored vital sign indicating the occupant is sleeping or falling asleep, the system may put itself into nap mode. In some cases, the system may be programmed to put itself into nap mode based on a set schedule. For example, the system may be programmed to put itself into nap mode every day from 1:00 PM until 3:00 PM. In some embodiments, the system may be prompted to activate nap mode. For example, an occupant may submit a command via a control panel of the home automation system, via a mobile application on a mobile device, and/or via a voice command such as “System, start nap mode.”

Upon entering nap mode, the system may modify one or more settings associated with automation of the home. For example, the system may modify an aspect of a chime for a doorbell at the home upon entering nap mode. In some cases, the doorbell may be configured to ring a dedicated doorbell chime mounted on a wall of the home. Additionally, or alternatively, the doorbell may be configured to play a chime over one or more speakers at the home. In some cases, the doorbell may be configured to play a chime and/or display a notification on a mobile device. Accordingly, upon entering nap mode the system may perform at least one of reduce a volume of the dedicated doorbell chime for a quieter chime sound, deactivate or mute the dedicated doorbell chime, activate or continue doorbell notifications on a mobile device, identify a room where the occupant is napping and play a doorbell chime over a first speaker in a room where an awake occupant is and bypass playing the doorbell chime over a second speaker in a room where the occupant is napping. Accordingly, in some embodiments, upon detecting a doorbell being rung at the home, the system may reduce a volume of a dedicated doorbell chime, mute the dedicated doorbell chime, bypass a dedicated chime, send a doorbell notification to a control panel (e.g., display text, play sound, flashing light, etc.), flash a light on a sensor, flash a security or strobe light, etc., send a doorbell notification to an alternative destination such as a mobile device, a television screen, send a notification to an alternative destination such as a text message to a mobile device, audio notification played via a mobile application installed on a mobile device, audio notification played through a speaker in a first room while bypassing playing the audio notification through a speaker in a second room, displaying a notification on a television screen, etc.

In some embodiments, the system may activate one or more sensors of the home automation system upon entering nap mode. In some cases, the system may mute a speaker in the room where the occupant is napping. In some embodiments, the system may play white noise and/or relaxing sounds (ocean, rain, running river, etc.) over the speaker in the room. In some cases, the system may mute the speaker for notifications such as a doorbell being pressed, etc., while playing the white noise and/or relaxing sounds over the speaker. Additionally, or alternatively, the system may activate a sleep sound machine in the room upon entering nap mode. In some embodiments, the system may activate a heating unit in the room via an appliance module (e.g. spacer heater connected to an appliance module). In some cases, the system may monitor one or more vital signs of the napping occupant and generate notifications based on the monitored vital signs. For example, a status update may be generated up request being made manually and/or based on a schedule of status updates at predetermined intervals such as a notification being generated and delivered every 20 minutes, for example.

Upon entering nap mode, the system may activate a decibel sensor in a room where the occupant is napping. In some cases, the decibel sensor may be configured to detect a noise in the room. Upon detecting the noise, the system may generate a notification indicating a noise was detected. In some cases, the system may be programmed to decipher the sound (e.g., compare the detected noise to a table of expected noises, perform frequency analysis, etc.) and determine whether the noise was made by the napping occupant. In some embodiments, when in nap mode the system may activate a motion sensor and/or security camera in the room where the occupant is napping and upon detecting motion generate a notification indicating motion was detected. In some embodiments, a camera in the room where the occupant is napping may include a speaker and/or a microphone. Accordingly, the camera may watch for motion, capture one or more images of the room, play soothing sleep sounds, and detect noises within the room. In some cases, a mobile application may be configured to control aspects of the camera, motion detector, decibel meter, sound machine, heating unit, speaker in the room where the occupant is napping, etc.

In some embodiments, the system may detect when a napping occupant is waking up and/or is awake. For example, the system may detect movement, sound, and or monitored vital signs that indicate the occupant that was napping is now awake. Upon determining the occupant is now awake, the system may generate a notification indicating the occupant is awake from his/her nap.

The following description provides examples and is not limiting of the scope, applicability, and/or examples set forth in the claims. Changes may be made in the function and/or arrangement of elements discussed without departing from the scope of the disclosure. Various examples may omit, substitute, and/or add various procedures and/or components as appropriate. For instance, the methods described may be performed in an order different from that described, and/or various steps may be added, omitted, and/or combined. Also, features described with respect to some examples may be combined in other examples.

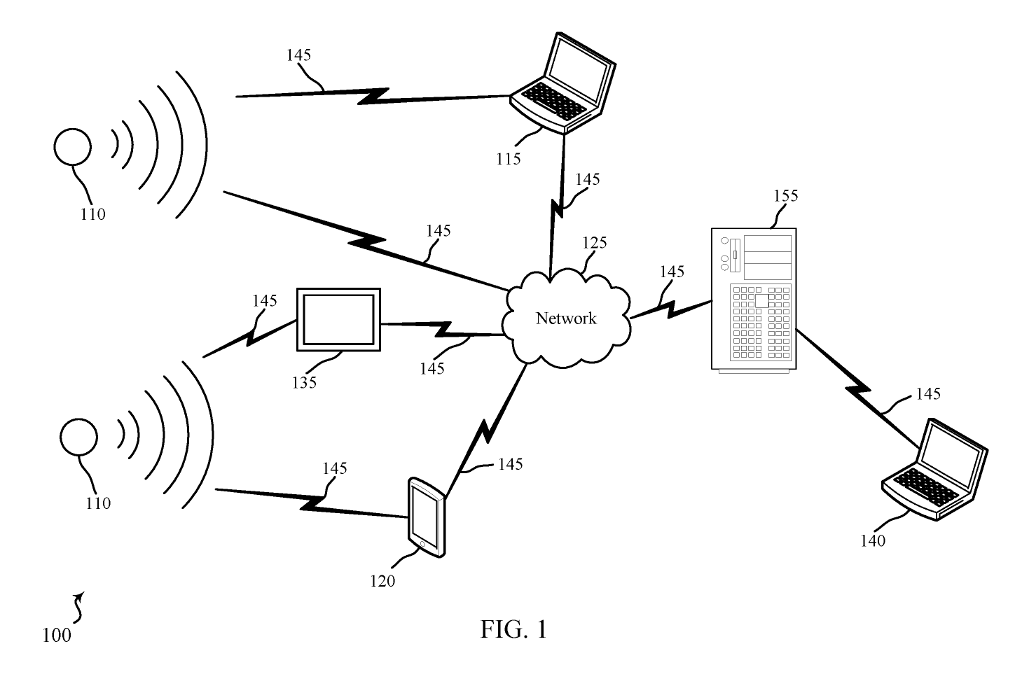

FIG. 1 is an example of a communications system 100 in accordance with various aspects of the disclosure. In some embodiments, the communications system 100 may include one or more sensor units 110, local computing device 115, 120, network 125, server 155, control panel 135, and remote computing device 140. One or more sensor units 110 may communicate via wired or wireless communication links 145 with one or more of the local computing device 115, 120 or network 125. The network 125 may communicate via wired or wireless communication links 145 with the control panel 135 and the remote computing device 140 via server 155. In alternate embodiments, the network 125 may be integrated with any one of the local computing device 115, 120, server 155, or remote computing device 140, such that separate components are not required.

Local computing device 115, 120 and remote computing device 140 may be custom computing entities configured to interact with sensor units 110 via network 125, and in some embodiments, via server 155. In other embodiments, local computing device 115, 120 and remote computing device 140 may be general purpose computing entities such as a personal computing device, for example, a desktop computer, a laptop computer, a netbook, a tablet personal computer (PC), a control panel, an indicator panel, a multi-site dashboard, an iPod®, an iPad®, a smart phone, a mobile phone, a personal digital assistant (PDA), and/or any other suitable device operable to send and receive signals, store and retrieve data, and/or execute modules.

Control panel 135 may be a smart home system panel, for example, an interactive panel mounted on a wall in a user's home. Control panel 135 may be in direct communication via wired or wireless communication links 145 with the one or more sensor units 110, or may receive sensor data from the one or more sensor units 110 via local computing devices 115, 120 and network 125, or may receive data via remote computing device 140, server 155, and network 125.

The local computing devices 115, 120 may include memory, a processor, an output, a data input and a communication module. The processor may be a general purpose processor, a Field Programmable Gate Array (FPGA), an Application Specific Integrated Circuit (ASIC), a Digital Signal Processor (DSP), and/or the like. The processor may be configured to retrieve data from and/or write data to the memory. The memory may be, for example, a random access memory (RAM), a memory buffer, a hard drive, a database, an erasable programmable read only memory (EPROM), an electrically erasable programmable read only memory (EEPROM), a read only memory (ROM), a flash memory, a hard disk, a floppy disk, cloud storage, and/or so forth. In some embodiments, the local computing devices 115, 120 may include one or more hardware-based modules (e.g., DSP, FPGA, ASIC) and/or software-based modules (e.g., a module of computer code stored at the memory and executed at the processor, a set of processor-readable instructions that may be stored at the memory and executed at the processor) associated with executing an application, such as, for example, receiving and displaying data from sensor units 110.

The processor of the local computing devices 115, 120 may be operable to control operation of the output of the local computing devices 115, 120. The output may be a television, a liquid crystal display (LCD) monitor, a cathode ray tube (CRT) monitor, speaker, tactile output device, and/or the like. In some embodiments, the output may be an integral component of the local computing devices 115, 120. Similarly stated, the output may be directly coupled to the processor. For example, the output may be the integral display of a tablet and/or smart phone. In some embodiments, an output module may include, for example, a High Definition Multimedia Interface™ (HDMI) connector, a Video Graphics Array (VGA) connector, a Universal Serial Bus™ (USB) connector, a tip, ring, sleeve (TRS) connector, and/or any other suitable connector operable to couple the local computing devices 115, 120 to the output.

The remote computing device 140 may be a computing entity operable to enable a remote user to monitor the output of the sensor units 110. The remote computing device 140 may be functionally and/or structurally similar to the local computing devices 115, 120 and may be operable to receive data streams from and/or send signals to at least one of the sensor units 110 via the network 125. The network 125 may be the Internet, an intranet, a personal area network, a local area network (LAN), a wide area network (WAN), a virtual network, a telecommunications network implemented as a wired network and/or wireless network, etc. The remote computing device 140 may receive and/or send signals over the network 125 via communication links 145 and server 155.

In some embodiments, the one or more sensor units 110 may be sensors configured to conduct periodic or ongoing automated measurements related to nap mode. Each sensor unit 110 may be capable of sensing multiple visual, aural, and/or vital sign parameters, or alternatively, separate sensor units 110 may monitor separate visual, aural, and/or vital sign parameters. For example, one sensor unit 110 may measure sound levels of a room, while another sensor unit 110 (or, in some embodiments, the same sensor unit 110) may detect motion in the room, and another sensor unit 110 (or again, in some embodiments, the same sensor unit 110) may detect vital signs of an occupant napping in the room.

Data gathered by the one or more sensor units 110 may be communicated to local computing device 115, 120, which may be, in some embodiments, a thermostat or other wall-mounted input/output smart home display. In other embodiments, local computing device 115, 120 may be a personal computer or smart phone. Where local computing device 115, 120 is a smart phone, the smart phone may have a dedicated application directed to collecting monitored data and calculating whether an occupant is napping therefrom. The local computing device 115, 120 may process the data received from the one or more sensor units 110 to obtain nap mode results. In alternate embodiments, remote computing device 140 may process the data received from the one or more sensor units 110, via network 125 and server 155, to obtain nap mode results. Data transmission may occur via, for example, frequencies appropriate for a personal area network (such as BLUETOOTH® or IR communications) or local or wide area network frequencies such as radio frequencies specified by the IEEE 802.15.4 standard.

In some embodiments, local computing device 115, 120 may communicate with remote computing device 140 or control panel 135 via network 125 and server 155. Examples of networks 125 include cloud networks, local area networks (LAN), wide area networks (WAN), virtual private networks (VPN), wireless networks (using 802.11, for example), and/or cellular networks (using 3G and/or LTE, for example), etc. In some configurations, the network 125 may include the Internet. In some embodiments, a user may access the functions of local computing device 115, 120 from remote computing device 140. For example, in some embodiments, remote computing device 140 may include a mobile application that interfaces with one or more functions of local computing device 115, 120.

The server 155 may be configured to communicate with the sensor units 110, the local computing devices 115, 120, the remote computing device 140 and control panel 135. The server 155 may perform additional processing on signals received from the sensor units 110 or local computing devices 115, 120, or may simply forward the received information to the remote computing device 140 and control panel 135.

Server 155 may be a computing device operable to receive data streams (e.g., from sensor units 110 and/or local computing device 115, 120 or remote computing device 140), store and/or process data, and/or transmit data and/or data summaries (e.g., to remote computing device 140). For example, server 155 may receive a stream of nap mode data from a sensor unit 110, a stream of nap mode data from the same or a different sensor unit 110, and a stream of nap mode data from either the same or yet another sensor unit 110. In some embodiments, server 155 may “pull” the data streams, e.g., by querying the sensor units 110, the local computing devices 115, 120, and/or the control panel 135. In some embodiments, the data streams may be “pushed” from the sensor units 110 and/or the local computing devices 115, 120 to the server 155. For example, the sensor units 110 and/or the local computing device 115, 120 may be configured to transmit data as it is generated by or entered into that device. In some instances, the sensor units 110 and/or the local computing devices 115, 120 may periodically transmit data (e.g., as a block of data or as one or more data points).

The server 155 may include a database (e.g., in memory) containing nap mode data received from the sensor units 110 and/or the local computing devices 115, 120. Additionally, as described in further detail herein, software (e.g., stored in memory) may be executed on a processor of the server 155. Such software (executed on the processor) may be operable to cause the server 155 to monitor, process, summarize, present, and/or send a signal associated with resource usage data.

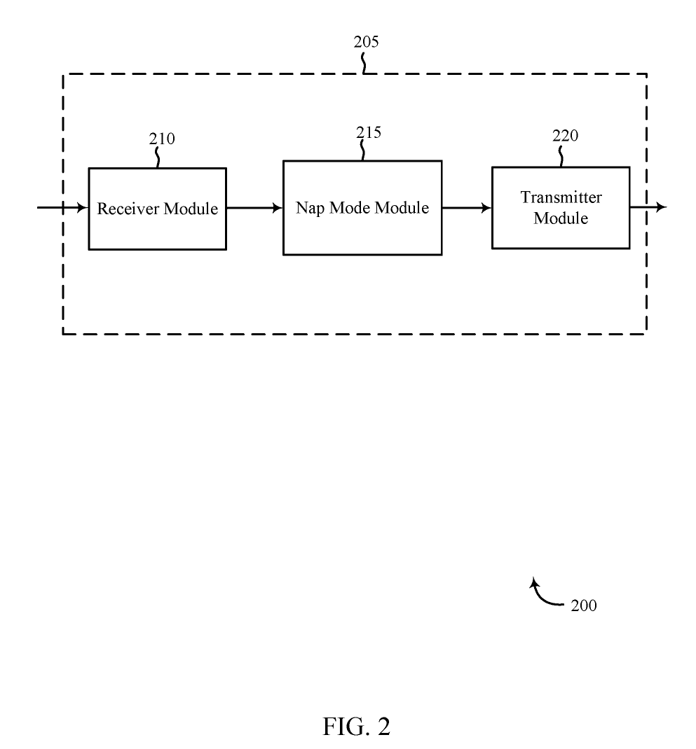

FIG. 2 shows a block diagram 200 of a control panel 205 for use in electronic communication, in accordance with various aspects of this disclosure. The control panel 205 may be an example of one or more aspects of a control panel 105 described with reference to FIG. 1. The control panel 205 may include a receiver module 210, a nap mode module 215, and/or a transmitter module 220. The control panel 205 may also be or include a processor. Each of these modules may be in communication with each other—directly and/or indirectly.

The components of the control panel 205 may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each module may also be implemented—in whole or in part—with instructions embodied in memory formatted to be executed by one or more general and/or application-specific processors.

The receiver module 210 may receive information such as packets, user data, and/or control information associated with various information channels (e.g., control channels, data channels, etc.). The receiver module 210 may be configured to receive monitored nap mode data such as any combination of monitored motion sensor data, monitored camera data, monitored sound level data, monitored vital sign data, etc. Information may be passed on to the nap mode module 215, and to other components of the control panel 205 for analysis.

Nap mode module 215 may receive data associated with nap mode such as any combination of monitored motion sensor data, monitored camera data, monitored sound level data, monitored vital sign data, etc., and process the received data to determine whether to initiate a nap mode, whether to continue a nap mode, and/or to whether to halt a nap mode.

The transmitter module 220 may transmit the one or more signals received from other components of the control panel 205. The transmitter module 220 may transmit notifications related to a nap mode and/or any combination of monitored nap mode data. In some examples, the transmitter module 220 may be collocated with the receiver module 210 in a transceiver module.

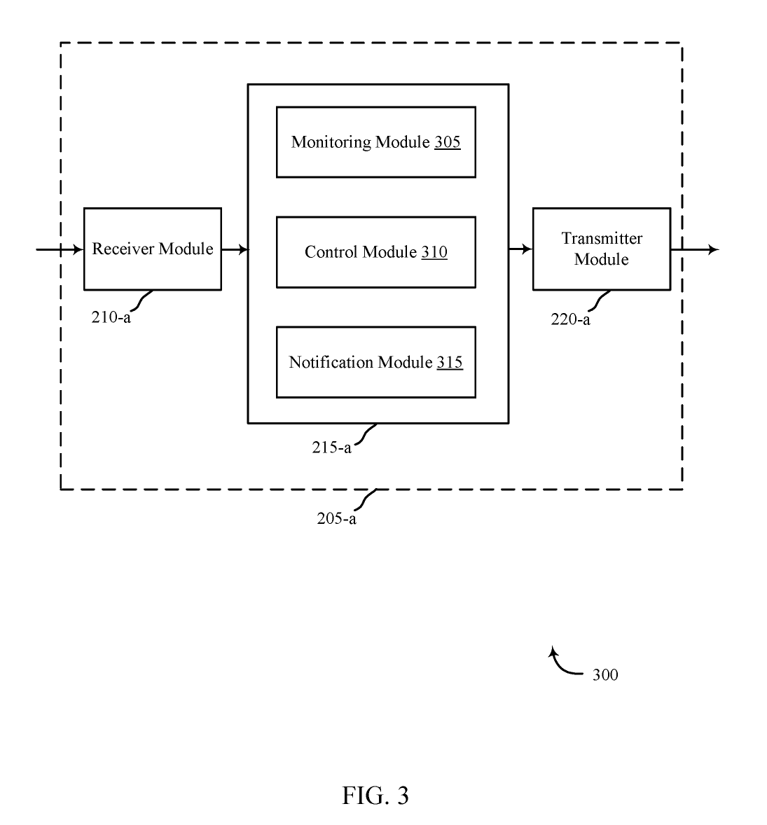

FIG. 3 shows a block diagram 300 of a control panel 205-a for use in wireless communication, in accordance with various examples. The control panel 205-a may be an example of one or more aspects of a control panel 105 described with reference to FIG. 1. It may also be an example of a control panel 205 described with reference to FIG. 2. The control panel 205-a may include a receiver module 210-a, a nap mode module 215-a, and/or a transmitter module 220-a, which may be examples of the corresponding modules of control panel 205. The control panel 205-a may also include a processor. Each of these components may be in communication with each other. The nap mode module 215-a may include monitoring module 305, control module 310, and notification module 315. The receiver module 210-a and the transmitter module 220-a may perform the functions of the receiver module 210 and the transmitter module 220, of FIG. 2, respectively.

The components of the control panel 205-a may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each module may also be implemented—in whole or in part—with instructions embodied in memory formatted to be executed by one or more general and/or application-specific processors.

In one embodiment, monitoring module 305 may detect a trigger for a nap mode of a home automation system. Upon detecting the nap mode trigger, control module 310 may activate the nap mode of the home automation system, including modifying an audio setting of a dedicated chime connected to a doorbell at a premises associated with the home automation system. In some cases, modifying the audio setting of the dedicated chime includes any combination of muting the dedicated chime, bypassing the dedicated chime, decreasing a volume of the dedicated chime, and playing a chime sound over a first speaker of the home automation system while bypassing playing the chime sound over a second speaker.

In some embodiments, monitoring module 305 may detect the doorbell at the premises being rung. In some configurations, control module 310 may route a doorbell notification to an alternative destination. In some cases, the doorbell notification includes any combination of a sound played on a mobile device, a message displayed on a mobile device, a message displayed on a television screen, a message displayed on a display of a control panel of a home automation system, flashing a light of a sensor of the home automation system (e.g., flashing a light on a motion sensor or other type of sensor), and flashing a security or strobe light of the home automation system. In some cases, a pattern may be flashed on a light. For example, four a security light of the premises may be flashed 4 times to indicate the doorbell is being pressed.

In some embodiments, monitoring module 305 may identify a room where an occupant is napping. In some cases, detecting a trigger for nap mode may include any combination of identifying a scheduled nap mode set for a predetermined period of time, identifying a voice command to initiate the nap mode, detecting an occupant in a bedroom lying down and remaining still for a predetermined amount of time, detecting a sound machine being activated, and monitoring a vital sign of the occupant that includes at least one of pulse, heart rate, breathing, breathing rate and determining the monitored vital sign indicates the occupant is napping. Thus, monitoring module 305 may identify a room where an occupant is napping by visually detecting via a camera at the premises that an occupant is lying down in a particular room, detecting the occupant remaining still for a predetermined amount of time in a particular room, receiving a voice command such as “System, initiate nap mode for the baby's room,” and so forth.

In some embodiments, control module 310 may link a room of a premises with a particular occupant of the premises (e.g., linked to occupant's name, to occupant's face via facial recognition, linked to occupant's voice via voice recognition, etc.). For example, control module 310 may link a baby's name to a baby's bedroom. In some embodiments, control module 310 may link one or more devices in the occupant's room with the occupant. For example, control module 310 may link any combination of one or more sensors, speakers, climate control devices (e.g., heaters, etc.), and other devices in the room to the particular occupant. Thus, when an occupant of the premises states, “I'm putting Arden down for a nap,” control module 310 may receive the voice prompt and process it to determine that Arden has one or more devices linked to her name, such as a sound machine in Arden's room, a space heater in Arden's room, one or more sensors in Arden's room such as motion sensors, camera sensors, decibel meters, etc. Thus, upon being notified that Arden is taking a nap, control module 310 may activate one or more of the devices in Arden's room for at least a portion of the time the system is in nap mode. In some cases, control module 310 may visually confirm that Arden is placed down for a nap in Arden's room based on one or more sensors in or located with respect to Arden's room. For example, a motion detector inside the room and/or with a view of the entrance to the room may indicate motion of an occupant entering Arden's room, a camera inside the room and/or with a view of the entrance to the room may detect an occupant entering Arden's room, etc., in relation to receiving the voice prompt indicated.

In one embodiment, upon detecting nap mode being triggered, control module 310 may mute one or more speakers relative to a room where an occupant is napping for the duration the home automation system is in nap mode. For example, upon determining an occupant is taking a nap on a couch in the family room, control module 310 may mute a speaker of the home automation system in the family room. In some cases, control module 310 may mute one or more speakers that are in locations adjacent to the family room. Thus, control module 310 may be configured to adjust the volumes of several speakers in the premises based on where the occupant is taking a nap. In some cases, control module 310 may mute a dedicated doorbell chime based on where the occupant is napping. For example, if the doorbell chime is located on a first floor and the occupant is sleeping on a second floor of the premises, control module 310 may allow the doorbell chime to play sound during nap mode. In some cases, control module 310 may reduce a volume of the doorbell chime during nap mode.

In some embodiments, upon detecting the trigger for the nap mode, control module 310 may play a sound in the room where an occupant is napping. In some cases, the sound played may include at least one of white noise and one or more sounds of nature such as ocean sounds, river sounds, rain sounds, wind sounds, etc. In some configurations, a camera in the room may include one or more speakers. Thus, in some cases, the sound may be played through the camera. In some embodiments, nap mode may be triggered by playing a sound machine. For example, an occupant may start a sound machine and monitoring module 305 may detect the sound machine being played. In some cases, a camera with a microphone and/or another device with a microphone in the same room as the sound machine may detect the sound machine. Upon detecting the sound, via monitoring module 305, control module 310 may initiate nap mode. In some embodiments, control module 310 may determine in what room the sound machine is being played and customize nap mode for the detected room. For example, an occupant may move a sound machine from a first room to a second room and start the sound machine in the second room. Upon detecting the sound machine in the second room, control module 310 may mute one or more speakers associated with the second room. Thus, when a doorbell is run, a chime sound may not be heard over the muted speakers. In some cases, the speakers associated with the first room may still allow the sound to be played in relation to the first room while muting the sound in the second room.

In some embodiments, upon detecting the trigger for nap mode, control module 310 may activate a heart monitoring and/or breathing rate of the napping occupant. In some cases, monitoring module 305 may monitor heart and/or breathing rates of an occupant to determine whether the occupant is falling asleep or taking a nap. Thus, in some cases, monitored heart and/or breathing rates of an occupant may trigger nap mode. In some embodiments, monitoring module 305 may monitor heart and/or breathing rates to enable control module 310 to determine whether the monitored rates indicate the occupant is waking up or is awake following a nap.

In some embodiments, control module 310 may activate a motion sensor in the room where an occupant is napping upon detecting the trigger for the nap mode. In some embodiments, monitoring module 305 may monitor the room where the occupant is napping for detectable motion. Upon detecting motion via monitoring module 305, control module 310 may analyze the motion to determine whether detected motion indicates the occupant is awake. For example, control module 310 may analyze the motion to determine whether the motion is an isolated movement of one still taking a nap such as a motion of turning from napping on one's side to one's back, etc., or whether the motion indicates the occupant has moved from a supine position to a sitting up or standing position.

In some cases, upon detecting the trigger for the nap mode, control module 310 may activate a decibel meter in the room where an occupant is napping. In some embodiments, monitoring module 305 may monitor an ambient noise level relative to the room where the occupant is napping. Upon detecting, via monitoring module 305, a noise that exceeds a predetermined threshold, control module 310 may adjust an aspect of a sound being played in the room to mask the detected noise. For example, control module 310 may increase the volume of the sound being played in the room, play more than one sound such as rain and ocean sounds, etc. In some cases, control module 310 may start playing white noise over a speaker in the room upon detecting noise that exceeds the predetermined threshold and adjust the level of white noise relative to the detected level of noise.

In some embodiments, a non-napping first occupant may query the system for updates regarding a napping second occupant. For example, the first occupant may ask “System, is the baby still napping?” In response, control module 310 may determine whether the second occupant is napping in conjunction with monitoring module 305 monitoring the sound, motion, heart/breathing rates, etc., of the second occupant. The system may generate a response indicating whether the second occupant appears to be napping. In some cases, the notification may include monitored data such as a decibel level of the room where the second occupant is napping, detected motion if any, an image captured of the second occupant after the query is made, monitored heart/breathing rates of the second occupant, etc.

In one embodiment, upon determining the occupant is awake after a nap, notification module 315 may generate a notification indicating the occupant is awake. The notification may include information regarding the nap such as length of nap, heart/breathing rate during the nap, motion and/or sounds detected during nap, operation of devices during the nap, confirmation of devices being deactivated at the conclusion of nap mode, etc. In some cases, upon determining the occupant is awake, control module 310 may deactivate nap mode. Deactivating nap mode may include restoring an audio setting of a dedicated doorbell chime to a default mode, unmuting one or more speakers muted upon triggering nap mode, deactivating one or more devices activated upon triggering nap mode such as a sound machine and/or a space heater, ceasing to monitor breathing/heart rate, deactivating one or more sensors such as decibel meter, motion sensor, etc. In some cases, the notification may include a prompt that requests the recipient to confirm that nap mode is to be deactivated. In some cases, control module 310 may deactivate nap mode if a response to the prompt is not received within a predetermined time.

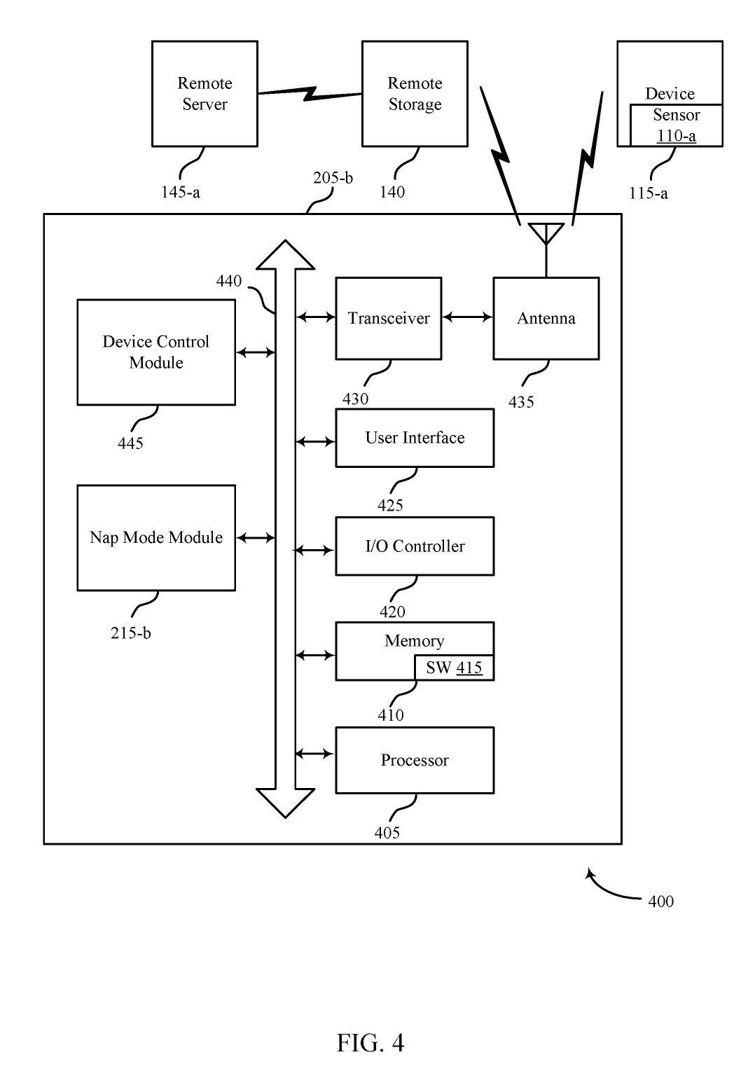

FIG. 4 shows a system 400 for use in security and/or automation systems, in accordance with various examples. System 400 may include a control panel 205-b, which may be an example of the control panels 105 of FIG. 1. Control panel 205-b may also be an example of one or more aspects of control panels 205 and/or 205-a of FIGS. 2 and 3. Control panel 205-b may include device control module 445, which may be an example of control module 310 described with reference to FIG. 2. In some embodiments, the terms a control panel and a control device are used synonymously.

Control panel 205-b may also include components for bi-directional voice and data communications including components for transmitting communications and components for receiving communications. For example, control panel 205-b may communicate bi-directionally with one or more of device 115-a, one or more sensors 110-a, remote storage 140, and/or remote server 145-a, which may be an example of the remote server of FIG. 1. This bi-directional communication may be direct (e.g., control panel 205-b communicating directly with remote storage 140) or indirect (e.g., control panel 205-b communicating indirectly with remote server 145-a through remote storage 140). Sensors 110-a may be examples of sensors 110 of FIG. 1.

The device control module 445 may control the operation of devices in a premises based at least in part on the triggering of nap mode as described above with reference to FIGS. 1-3. For example, device control module 445 may activate a space heater and/or a sound machine in a room of the premises where an occupant is taking a nap.

Control panel 205-b may also include a processor module 405, and memory 410 (including software/firmware code (SW) 415), an input/output controller module 420, a user interface module 425, a transceiver module 430, and one or more antennas 435 each of which may communicate—directly or indirectly—with one another (e.g., via one or more buses 440). The transceiver module 430 may communicate bi-directionally—via the one or more antennas 435, wired links, and/or wireless links—with one or more networks or remote devices as described above. For example, the transceiver module 430 may communicate bi-directionally with one or more of device 115-a, remote storage 140, and/or remote server 145-a. The transceiver module 430 may include a modem to modulate the packets and provide the modulated packets to the one or more antennas 435 for transmission, and to demodulate packets received from the one or more antenna 435. While a control panel or a control device (e.g., 205-b) may include a single antenna 435, the control panel or the control device may also have multiple antennas 435 capable of concurrently transmitting or receiving multiple wired and/or wireless transmissions. In some embodiments, one element of control panel 205-b (e.g., one or more antennas 435, transceiver module 430, etc.) may provide a direct connection to a remote server 145-a via a direct network link to the Internet via a POP (point of presence). In some embodiments, one element of control panel 205-b (e.g., one or more antennas 435, transceiver module 430, etc.) may provide a connection using wireless techniques, including digital cellular telephone connection, Cellular Digital Packet Data (CDPD) connection, digital satellite data connection, and/or another connection.

The signals associated with system 400 may include wireless communication signals such as radio frequency, electromagnetics, local area network (LAN), wide area network (WAN), virtual private network (VPN), wireless network (using 802.11, for example), 345 MHz, Z-WAVE®, cellular network (using 3G and/or LTE, for example), and/or other signals. The one or more antennas 435 and/or transceiver module 430 may include or be related to, but are not limited to, WWAN (GSM, CDMA, and WCDMA), WLAN (including BLUETOOTH® and Wi-Fi), WMAN (WiMAX), antennas for mobile communications, antennas for Wireless Personal Area Network (WPAN) applications (including RFID and UWB). In some embodiments, each antenna 435 may receive signals or information specific and/or exclusive to itself. In other embodiments, each antenna 435 may receive signals or information not specific or exclusive to itself.

In some embodiments, one or more sensors 110-a (e.g., motion, proximity, smoke, light, glass break, door, window, carbon monoxide, and/or another sensor) may connect to some element of system 400 via a network using one or more wired and/or wireless connections.

In some embodiments, the user interface module 425 may include an audio device, such as an external speaker system, an external display device such as a display screen, and/or an input device (e.g., remote control device interfaced with the user interface module 425 directly and/or through I/O controller module 420).

One or more buses 440 may allow data communication between one or more elements of control panel 205-b (e.g., processor module 405, memory 410, I/O controller module 420, user interface module 425, etc.).

The memory 410 may include random access memory (RAM), read only memory (ROM), flash RAM, and/or other types. The memory 410 may store computer-readable, computer-executable software/firmware code 415 including instructions that, when executed, cause the processor module 405 to perform various functions described in this disclosure (e.g., detecting a nap mode trigger, initiating nap mode, monitoring one or more aspects during nap mode, adjusting one or more aspects of a security/automation system during nap mode, etc.). Alternatively, the software/firmware code 415 may not be directly executable by the processor module 405 but may cause a computer (e.g., when compiled and executed) to perform functions described herein. Alternatively, the computer-readable, computer-executable software/firmware code 415 may not be directly executable by the processor module 405 but may be configured to cause a computer (e.g., when compiled and executed) to perform functions described herein. The processor module 405 may include an intelligent hardware device, e.g., a central processing unit (CPU), a microcontroller, an application-specific integrated circuit (ASIC), etc.

In some embodiments, the memory 410 can contain, among other things, the Basic Input-Output system (BIOS) which may control basic hardware and/or software operation such as the interaction with peripheral components or devices. For example, the device control module 445 and/or nap mode module 215-b to implement the present systems and methods may be stored within the system memory 410. Applications resident with system 400 are generally stored on and accessed via a non-transitory computer readable medium, such as a hard disk drive or other storage medium. Additionally, applications can be in the form of electronic signals modulated in accordance with the application and data communication technology when accessed via a network interface (e.g., transceiver module 430, one or more antennas 435, etc.).

Many other devices and/or subsystems may be connected to one or may be included as one or more elements of system 400 (e.g., entertainment system, computing device, remote cameras, wireless key fob, wall mounted user interface device, cell radio module, battery, alarm siren, door lock, lighting system, thermostat, home appliance monitor, utility equipment monitor, and so on). In some embodiments, all of the elements shown in FIG. 4 need not be present to practice the present systems and methods. The devices and subsystems can be interconnected in different ways from that shown in FIG. 4. In some embodiments, an aspect of some operation of a system, such as that shown in FIG. 4, may be readily known in the art and are not discussed in detail in this application. Code to implement the present disclosure can be stored in a non-transitory computer-readable medium such as one or more of system memory 410 or other memory. The operating system provided on I/O controller module 420 may be iOS®, ANDROID®, MS-DOS®, MS-WINDOWS®, OS/2®, UNIX®, LINUX®, or another known operating system.

The transceiver module 430 may include a modem configured to modulate the packets and provide the modulated packets to the antennas 435 for transmission and/or to demodulate packets received from the antennas 435. While the control panel or control device (e.g., 205-b) may include a single antenna 435, the control panel or control device (e.g., 205-b) may have multiple antennas 435 capable of concurrently transmitting and/or receiving multiple wireless transmissions.

The control panel 205-b may include a nap mode module 215-b, which may perform the functions described above for the nap mode modules 215 of control panel 205 of FIGS. 2 and/or 3.

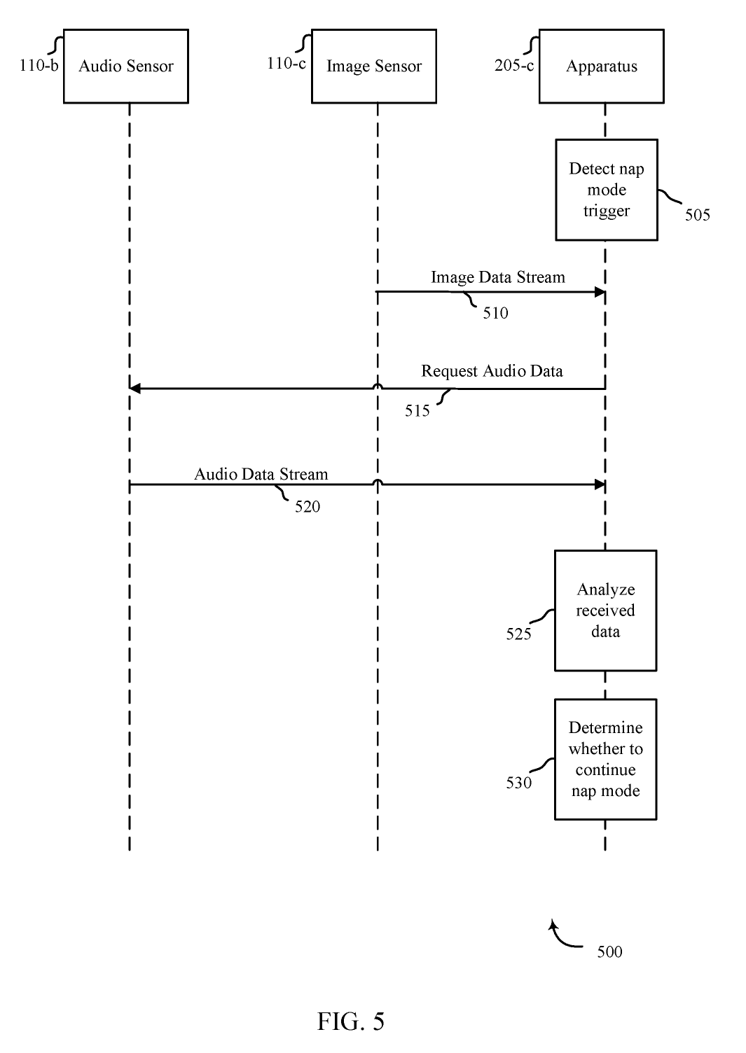

FIG. 5 shows a block diagram of a data flow 500 relating to a security and/or an automation system, in accordance with various aspects of this disclosure. The data flow 500 illustrates the flow of data between an audio sensor 110-b, an image sensor 110-c, and an apparatus 205-c. The audio and/or image sensors 110 may be examples of one or more aspects of sensor 110 from FIGS. 1 and/or 4. Apparatus 205-c may be an example of one or more aspects of control panel 135 of FIG. 1, and/or apparatus 205 of FIGS. 2-4. In some cases, apparatus 205-c may include a computing device such as a smart phone, desktop, laptop, remote server (e.g., server 155 of FIG. 1). In some cases, apparatus 205-c may include a storage device and/or database.

At block 505, apparatus 205-c may detect a nap mode trigger. In some cases, apparatus 205-c may detect the trigger in conjunction with audio sensor 110-b and/or image sensor 110-c. For example, in one example, audio sensor 110-b may detect a sound machine being played and/or receive an audio command to initiate nap mode. In one embodiment, image sensor 110-c may send an image data stream 510 to apparatus 205-c. Apparatus 205-c may analyze the image data stream 510 to determine whether an occupant has started a nap, whether the occupant continues napping or whether the occupant has woken from a nap. In some embodiments, apparatus 205-c may send a request 515 for audio data. In response, audio sensor 110-b may send audio data stream 520 to apparatus 205-c. For example, audio sensor 110-b may measure an ambient sound level associated with a room where the occupant sleeps and send data related to the measured sound to apparatus 205-c.

At block 525, apparatus 205-c may analyze the received data, which may include image data stream 510 and/or audio data stream 520. Based on the analysis of the received data, at block 530, apparatus 205-c may determine whether to continue operating in nap mode or whether to terminate nap mode upon determining the received data indicates the occupant is no longer napping.

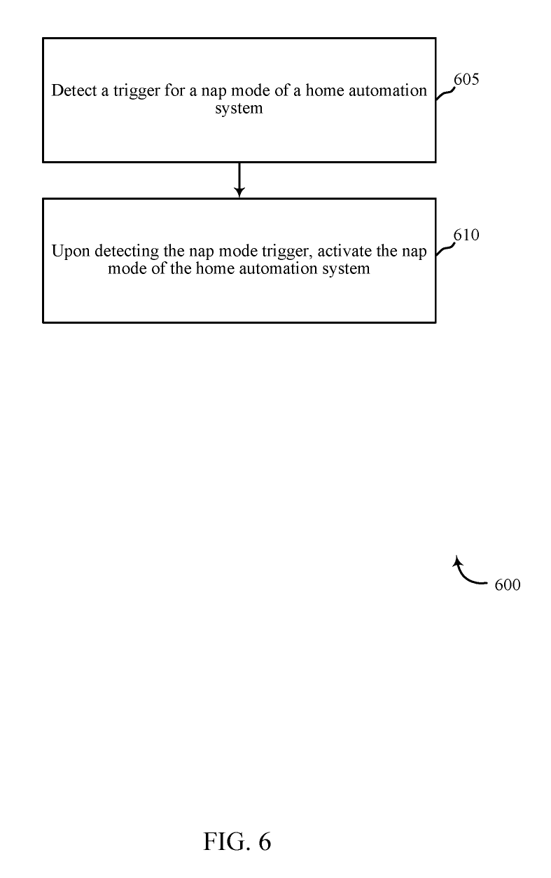

FIG. 6 is a flow chart illustrating an example of a method 600 for operating a nap mode, in accordance with various aspects of the present disclosure. For clarity, the method 600 is described below with reference to aspects of one or more of the sensors 110 described with reference to FIGS. 1, 4, and/or 5. In some examples, a control panel, backend server, and/or one or more sensors may execute one or more sets of codes to control the functional elements of the security/automation system to perform the functions described below. Additionally or alternatively, the control panel, backend server, and/or one or more sensors may perform one or more of the functions described below using special-purpose hardware.

At block 605, the method 600 may include detecting a trigger for a nap mode of a home automation system. At block 610, upon detecting the nap mode trigger, the method 600 may include activating the nap mode of the home automation system. In some cases, activating the nap mode may include modifying an audio setting of a dedicated chime connected to a doorbell at a premises associated with the home automation system. For example, the dedicated chime may be muted to remove sound when the doorbell is pressed or muffled to minimize a sound level of the dedicated chime when the doorbell is pressed. In some cases, a signal from the doorbell may be configured to bypass activating the sound mechanism of the dedicated doorbell chime and rerouted to one or more other devices to indicate the doorbell being pressed, such as playing a sound over a speaker, flashing a light, sending a notification to a device such as a mobile phone, control panel, television, etc.

The operation(s) of method 600 may be performed using the nap mode module 215 described with reference to FIGS. 2, 3, and/or 4. Thus, the method 600 may provide for operating in a nap mode relating to automation/security systems. It should be noted that the method 600 is just one implementation and that the operations of the method 600 may be rearranged or otherwise modified such that other implementations are possible.

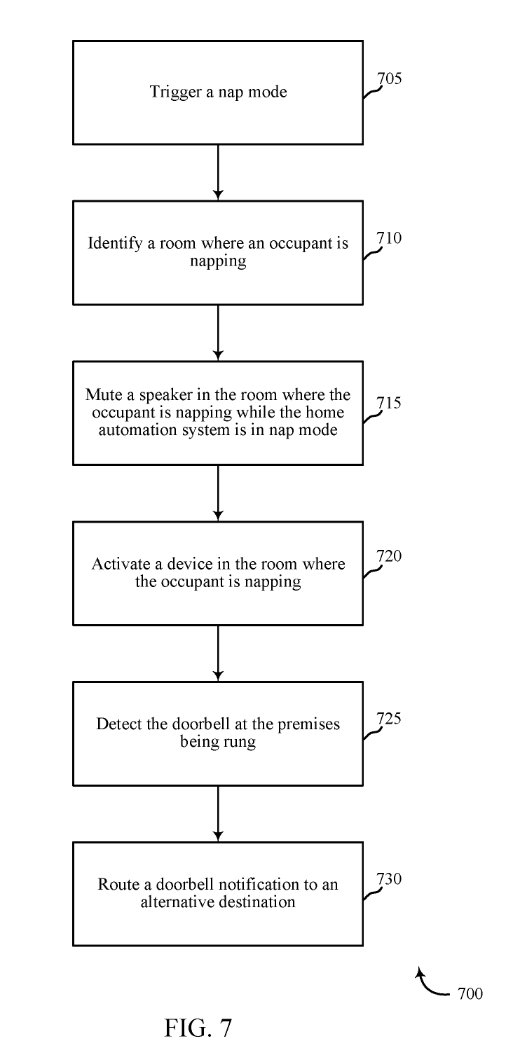

FIG. 7 is a flow chart illustrating an example of a method 700 for operating a nap mode, in accordance with various aspects of the present disclosure. For clarity, the method 700 is described below with reference to aspects of one or more of the sensors 110 described with reference to FIGS. 1, 4, and/or 5. In some examples, a control panel, backend server, and/or one or more sensors may execute one or more sets of codes to control the functional elements of the security/automation system to perform the functions described below. Additionally or alternatively, the control panel, backend server, and/or one or more sensors may perform one or more of the functions described below using special-purpose hardware.

At block 705, the method 700 may include identifying a room where an occupant is napping. At block 710, the method 700 may include muting a speaker in the room where the occupant is napping while the home automation system is in nap mode. Upon detecting the trigger for the nap mode, at block 715, the method 700 may include activating a device in the room where the occupant is napping. For example, the method 700 may activate a motion sensor, camera, sound machine, space heater, vital sign monitor, etc., in the room where the occupant is napping. At block 720, the method 700 may include detecting the doorbell at the premises being rung. At block 725, the method 700 may include routing a doorbell notification to an alternative destination such as a mobile device instead of a dedicated doorbell chime, etc. In some cases, the alternative doorbell notification may include at least one of a sound played on a mobile device, a message displayed on the mobile device, a message displayed on a television screen, a message displayed on a control panel of the home automation system, flashing a light of a sensor of the home automation system, and flashing a security or strobe light of the home automation system.

The operation(s) of method 700 may be performed using the nap mode module 215 described with reference to FIGS. 2, 3, and/or 4. Thus, the method 700 may provide for operating in a nap mode relating to automation/security systems. It should be noted that the method 700 is just one implementation and that the operations of the method 700 may be rearranged or otherwise modified such that other implementations are possible.

In some examples, aspects from two or more of the methods 600 and 700 may be combined and/or separated. It should be noted that the methods 600 and 700 are just example implementations, and that the operations of the methods 600 and 700 may be rearranged or otherwise modified such that other implementations are possible.

The detailed description set forth above in connection with the appended drawings describes examples and does not represent the only instances that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with this disclosure may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, and/or state machine. A processor may also be implemented as a combination of computing devices, e.g., a combination of a DSP and a microprocessor, multiple microprocessors, one or more microprocessors in conjunction with a DSP core, and/or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

In addition, any disclosure of components contained within other components or separate from other components should be considered exemplary because multiple other architectures may potentially be implemented to achieve the same functionality, including incorporating all, most, and/or some elements as part of one or more unitary structures and/or separate structures.

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM, DVD, or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein, but is to be accorded the broadest scope consistent with the principles and novel features disclosed.

This disclosure may specifically apply to security system applications. This disclosure may specifically apply to automation system applications. In some embodiments, the concepts, the technical descriptions, the features, the methods, the ideas, and/or the descriptions may specifically apply to security and/or automation system applications. Distinct advantages of such systems for these specific applications are apparent from this disclosure.

The process parameters, actions, and steps described and/or illustrated in this disclosure are given by way of example only and can be varied as desired. For example, while the steps illustrated and/or described may be shown or discussed in a particular order, these steps do not necessarily need to be performed in the order illustrated or discussed. The various exemplary methods described and/or illustrated here may also omit one or more of the steps described or illustrated here or include additional steps in addition to those disclosed.

Furthermore, while various embodiments have been described and/or illustrated here in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may permit and/or instruct a computing system to perform one or more of the exemplary embodiments disclosed here.

This description, for purposes of explanation, has been described with reference to specific embodiments. The illustrative discussions above, however, are not intended to be exhaustive or limit the present systems and methods to the precise forms discussed. Many modifications and variations are possible in view of the above teachings. The embodiments were chosen and described in order to explain the principles of the present systems and methods and their practical applications, to enable others skilled in the art to utilize the present systems, apparatus, and methods and various embodiments with various modifications as may be suited to the particular use contemplated.

What is claimed is:

1. A method for security and/or automation systems, comprising:
detecting a trigger for a nap mode of a home automation system; and
upon detecting the nap mode trigger, activating the nap mode of the home automation system, including modifying an audio setting of a dedicated chime connected to a doorbell at a premises associated with the home automation system.

2. The method of claim 1, wherein modifying the audio setting of the dedicated chime includes at least one of muting the dedicated chime, bypassing the dedicated chime, decreasing a volume of the dedicated chime, and playing a chime sound over a first speaker of the home automation system while bypassing playing the chime sound over a second speaker.

3. The method of claim 1, comprising:
detecting the doorbell at the premises being rung; and
routing a doorbell notification to an alternative destination, wherein the doorbell notification includes at least one of a sound played on a mobile device, a message displayed on the mobile device, a message displayed on a television screen, a message displayed on a control panel of the home automation system, flashing a light of a sensor of the home automation system, and flashing a security or strobe light of the home automation system.

4. The method of claim 1, comprising:
identifying a room where an occupant is napping; and
muting a speaker in the room where the occupant is napping while the home automation system is in nap mode.

5. The method of claim 1, wherein detecting the trigger for the nap mode includes at least one of identifying a scheduled nap mode set for a predetermined period of time, identifying a voice command to initiate the nap mode, detecting an occupant in a bedroom lying down and remaining still for a predetermined amount of time, detecting a sound machine being activated, and monitoring a vital sign of the occupant that includes at least one of pulse, heart rate, breathing, breathing rate and determining the monitored vital sign indicates the occupant is napping.

6. The method of claim 1, comprising:
upon detecting the trigger for the nap mode, activating a motion sensor in the room where an occupant is napping; and
determining whether detected motion indicates the occupant is awake.

7. The method of claim 1, comprising:
upon detecting the trigger for the nap mode, activating a decibel meter in the room where an occupant is napping; and
determining whether a detected sound indicates the occupant is awake.

8. The method of claim 1, comprising:
upon detecting the trigger for the nap mode, playing a sound in the room where an occupant is napping, the sound including at least one of white noise and one or more sounds of nature comprising ocean sounds, river sounds, rain sounds, wind sounds.

9. The method of claim 8, comprising:
measuring an ambient noise level relative to the room where the occupant is napping; and
upon detecting a noise that exceeds a predetermined threshold, adjusting an aspect of the sound being played in the room to mask the detected noise.

10. The method of claim 1, comprising:
upon determining the occupant is awake after a nap, generating a notification indicating the occupant is awake, deactivating nap mode, and restoring the audio setting of the chime to a default mode.

11. An apparatus for security and/or automation systems, comprising:
a processor;
memory in electronic communication with the processor; and
instructions stored in the memory, the instructions being executable by the processor to perform the steps of:
detecting a trigger for a nap mode of a home automation system; and
upon detecting the nap mode trigger, activating the nap mode of the home automation system, including modifying an audio setting of a dedicated chime connected to a doorbell at a premises associated with the home automation system.

12. The apparatus of claim 11, wherein modifying the audio setting of the dedicated chime includes at least one of muting the dedicated chime, bypassing the dedicated chime, decreasing a volume of the dedicated chime, and playing a chime sound over a first speaker of the home automation system while bypassing playing the chime sound over a second speaker.

13. The apparatus of claim 11, the instructions being executable by the processor to perform the steps of:
detecting the doorbell at the premises being rung; and
routing a doorbell notification to an alternative destination, wherein the doorbell notification includes at least one of a sound played on a mobile device, a message displayed on the mobile device, a message displayed on a television screen, a message displayed on a control panel of the home automation system, flashing a light of a sensor of the home automation system, and flashing a security or strobe light of the home automation system.

14. The apparatus of claim 11, the instructions being executable by the processor to perform the steps of:
identifying a room where an occupant is napping; and
muting a speaker in the room where the occupant is napping while the home automation system is in nap mode.

15. The apparatus of claim 11, the instructions being executable by the processor to perform the steps of:
wherein detecting the trigger for the nap mode includes at least one of identifying a scheduled nap mode set for a predetermined period of time, identifying a voice command to initiate the nap mode, detecting an occupant in a bedroom lying down and remaining still for a predetermined amount of time, detecting a sound machine being activated, and monitoring a vital sign of the occupant that includes at least one of pulse, heart rate, breathing, breathing rate and determining the monitored vital sign indicates the occupant is napping.

16. The apparatus of claim 11, the instructions being executable by the processor to perform the steps of:
upon detecting the trigger for the nap mode, activating a motion sensor in the room where an occupant is napping; and
determining whether detected motion indicates the occupant is awake.

17. The apparatus of claim 11, the instructions being executable by the processor to perform the steps of:
upon detecting the trigger for the nap mode, activating a decibel meter in the room where an occupant is napping; and
determining whether a detected sound indicates the occupant is awake.

18. The apparatus of claim 11, the instructions being executable by the processor to perform the steps of:
upon detecting the trigger for the nap mode, playing a sound in the room where an occupant is napping, the sound including at least one of white noise and one or more sounds of nature comprising ocean sounds, river sounds, rain sounds, and wind sounds.

19. The apparatus of claim 18, the instructions being executable by the processor to perform the steps of:
measuring an ambient noise level relative to the room where the occupant is napping; and
upon detecting a noise that exceeds a predetermined threshold, adjusting an aspect of the sound being played in the room to mask the detected noise

20. A non-transitory computer-readable medium storing computer-executable code, the code executable by a processor to perform the steps of:
detecting a trigger for a nap mode of a home automation system; and
upon detecting the nap mode trigger, activating the nap mode of the home automation system, including modifying an audio setting of a dedicated chime connected to a doorbell at a premises associated with the home automation system.
